(19) United States
(12) Patent Application Publication
(10) Pub. No.: US 2026/0206995 A1
(43) Pub. Date: Jul. 23, 2026

(54) COFFEE FILTER CUP

(71) Applicant: Ramsey James GYDE, Hong Kong (CN)

(72) Inventor: Ramsey James GYDE, Hong Kong (CN)

(21) Appl. No.: 19/570,448

(22) Filed: Mar. 18, 2026

Related U.S. Application Data
(63) Continuation of application No. PCT/CN2024/119480, filed on Sep. 18, 2024.

(30) Foreign Application Priority Data
Sep. 18, 2023 (CN) 202322533908.6

(51) Int. Cl. A47J 31/06; B01D 29/05

(52) U.S. Cl. CPC A47J 31/06; B01D 29/05; B01D 2201/4092

(57) ABSTRACT

A coffee filter cup includes a cup body, a filter screen, and a cup holder. A bottom of the cup body is hollowed to form a first opening, a second opening is provided in a middle of the cup holder, and the cup body and the cup holder are connected through a detachable fixed connection mode between the first opening and the second opening; and when the cup body and the cup holder are in a connected state, an edge of the filter screen is clamped by the cup body and the cup holder. The coffee filter cup, on the one hand, allows the filter screen to be flexibly replaced according to coffee types and taste requirements, and on the other hand, improves a contact mode of air, coffee powder, and water flow, thereby improving coffee flavor.

### CROSS-REFERENCE TO RELATED APPLICATIONS

The present disclosure is a continuation of International Application No. PCT/CN2024/119480, filed on Sep. 18, 2024, which claims priority to Chinese Patent Application No. 202322533908.6, filed on Sep. 18, 2023. All of the aforementioned applications are incorporated herein by reference in their entireties.

### TECHNICAL FIELD

The present disclosure relates to the field of a coffee making device, and in particular to a coffee filter cup.

### BACKGROUND

A coffee filter cup is a commonly used device in a coffee-making process, and its function mainly lies in two aspects: one is to filter coffee powder (coffee grounds), and the other is to control a fusion method of water flow, coffee, and air during a filtration process, thereby improving the aroma of the coffee to a certain extent.

A general-purpose coffee filter cup has a simple structure, in which a bottom of the cup is replaced by a filter screen. The drawback of this structure is that different types of coffee or coffee powders with different grinding degrees should be matched with different filter screens to obtain different filtration efficiencies and coffee flavors. However, the filter screen of the general-purpose filter cup is fixedly connected to a cup body, making it impossible to flexibly adjust according to different coffee powders. In addition, the filter screen is a component requiring focused cleaning and thus has a much higher chance of wear or damage than the cup body. Once the filter screen of a general-purpose filter cup is damaged, the entire cup body also becomes unusable, resulting in waste.

### SUMMARY

In view of the drawback of the prior art mentioned above, the present disclosure provides a coffee filter cup, which includes a cup body, a filter screen, and a cup holder. A bottom of the cup body is hollowed to form a first opening, a second opening is provided in a middle of the cup holder, and the cup body and the cup holder are connected through a detachable fixed connection mode between the first opening and the second opening; and when the cup body and the cup holder are in a connected state, an edge of the filter screen is clamped by the cup body and the cup holder.

Preferably, in the coffee filter cup, the detachable fixed connection mode is selected from one of threaded connection, snap-fitting connection, or sleeve connection by interference fit.

Preferably, when the detachable fixed connection mode is a threaded connection, the bottom of the cup body is provided with a first thread surrounding the first opening, and the cup holder is provided with a second thread cooperating with the first thread.

Preferably, in the coffee filter cup, the cup body includes an inner wall and an outer wall, with a hollow portion formed between the inner wall of the cup body and the outer wall of the cup body.

Preferably, in the coffee filter cup, the hollow portion is evacuated to form a vacuum or quasi-vacuum.

Preferably, in the coffee filter cup, the filter screen has a three-dimensional structure with a central portion lower than an edge portion.

Preferably, the three-dimensional structure transitions between the central portion and the edge portion through multi-level steps.

Preferably, each level of the multi-level steps is provided with filter holes.

Preferably, the filter holes provided on each level of the multi-level steps have same or different shapes from each other.

Preferably, the filter holes provided on each level of the multi-level steps have same or different densities from each other.

Preferably, the bottom of the cup body forms a lower end connecting structure surrounding the first opening, and a lower edge of the lower end connecting structure constitutes an annular pressing portion for the edge of the filter screen.

Preferably, the cup holder has an annular support portion, and when the cup body and the cup holder are connected, the annular support portion and the annular pressing portion jointly clamp the edge of the filter screen.

Preferably, a wall structure is formed around the second opening, the wall structure includes an inner wall and an outer wall, the inner wall of the wall structure is located on a side close to the second opening, and an upper edge of the inner wall of the wall structure constitutes the annular support portion; the inner wall of the wall structure and the outer wall of the wall structure are connected at a lower portion to form a space between the inner wall of the wall structure and the outer wall of the wall structure for accommodating the lower end connecting structure.

The coffee filter cup of the present disclosure, on the one hand, allows the filter screen to be flexibly replaced according to coffee types and taste requirements, and on the other hand, improves a contact mode among air, coffee powder, and water flow, thereby improving coffee flavor. According to a preferred embodiment, it can also effectively avoid safety hazards caused by boiling water splashing and hot cup body scalding, thus having high practical value.

### BRIEF DESCRIPTION OF THE DRAWINGS

FIG. 1 shows an exploded view of an embodiment of a coffee filter cup of the present disclosure.

FIG. 2 shows a longitudinal sectional view of the embodiment of FIG. 1 in an assembled state.

FIG. 3 shows a side view of a filter screen in the embodiment of FIG. 1.

### DETAILED DESCRIPTION OF THE EMBODIMENTS

The following describes the implementation of the present disclosure through specific examples. Those skilled in the art can easily understand other advantages and effects of the present disclosure from the content disclosed in this specification. The present disclosure can also be implemented or applied through other specific embodiments. Various details in this specification can be modified or changed based on different viewpoints and applications without departing from the spirit of the present disclosure.

Please refer to the drawings below. It should be noted that the diagrams provided in this embodiment are only schematic illustrations of the basic concept of the present disclosure. Therefore, the diagrams only show components related to the present disclosure and are not drawn according to the actual number, shape, and size of components during implementation. The actual implementation may involve arbitrary changes in the type, quantity, and proportion of components, and the layout of components may be more complex. Unless otherwise specified, directional terms such as “up”, “down”, “left”, and “right” used in the text are based on the perspective of the observer in the drawings.

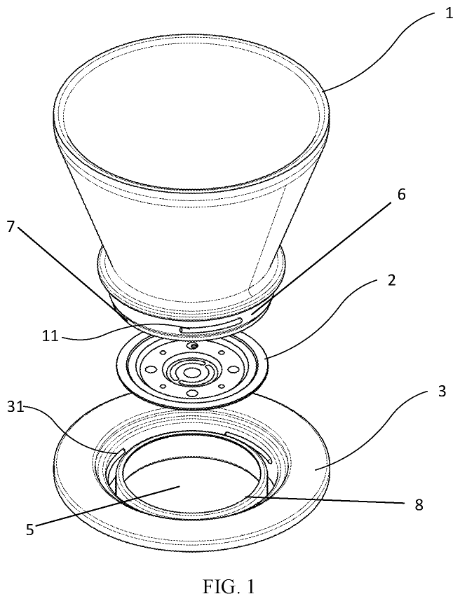

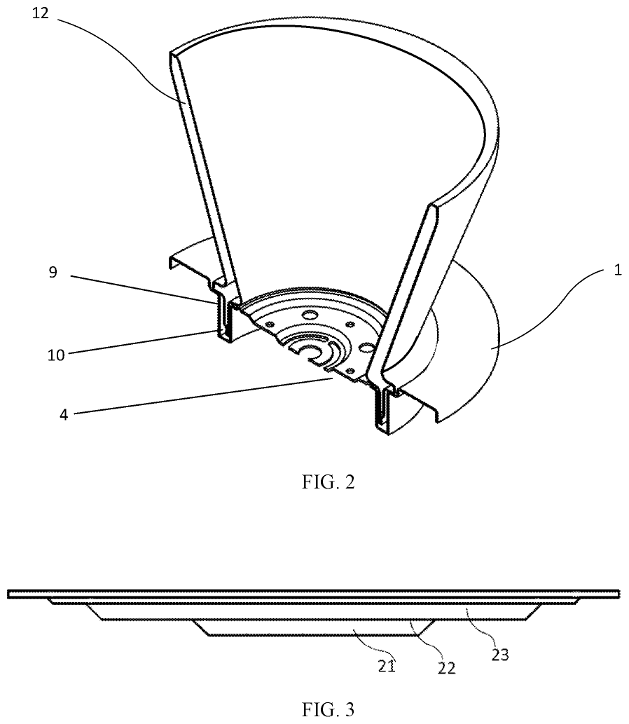

FIG. 1 shows an exploded view of an embodiment of a coffee filter cup of the present disclosure. FIG. 2 shows a longitudinal sectional view of the embodiment of FIG. 1 in an assembled state. The coffee filter cup of the present disclosure includes: a cup body 1, a filter screen 2, and a cup holder 3. A bottom of the cup body 1 is hollowed to form a first opening 4, an outer wall of the first opening 4 at the bottom of the cup body 1 is provided with a first thread 11. A middle of the cup holder 3 is provided with a second opening 5, and an inner wall of the second opening 5 is provided with a second thread 31 matching the first thread 11, thereby forming a detachable fixed connection between the cup body 1 and the cup holder 3. The above is merely an explanatory example using a threaded connection to illustrate the connection method between the cup body 1 and the cup holder 3 in the present disclosure, and does not represent a limitation on the protection scope. In the present disclosure, other connection methods, such as a snap-fitting connection or sleeve connection by interference fit, may also be adopted to connect the cup body 1 and the cup holder 3. The structural arrangement and mutual cooperation of these connection methods are similar to those of the threaded connection in this embodiment. A central portion of the filter screen 2 is provided with filter holes. An assembled state of the cup body 1, the filter screen 2, and the cup holder 3 is shown in FIG. 2. In the assembled state, the cup body 1 and the cup holder 3 clamp an edge of the filter screen 2, thereby fixing the filter screen 2 to the bottom of the cup body 1.

The bottom of the cup body 1 forms a lower end connecting structure 6 surrounding the first opening 4, and a lower edge of the lower end connecting structure 6 constitutes an annular pressing portion 7 for an edge of the filter screen 2; further, an inner wall and an outer wall of the cup body 1 jointly form the lower end connecting structure 6 at the bottom surrounding the first opening 4. The cup holder 3 has an annular support portion 8, and when the cup body 1 and the cup holder 3 are connected, the annular support portion 8 and the annular pressing portion 7 jointly clamp the edge of the filter screen 2.

A wall structure 9 is formed around the second opening 5, the wall structure 9 includes an inner wall and an outer wall, the inner wall of the wall structure 9 is located on a side close to the second opening 5, and an upper edge of the inner wall of the wall structure 9 constitutes the annular support portion 8 for supporting the edge of the filter screen 2; the inner wall of the wall structure 9 and the outer wall of the wall structure 9 are connected at a lower portion to form a space 10 between the inner wall of the wall structure 9 and the outer wall of the wall structure 9 for accommodating the lower end connecting structure 6. When the cup body 1 is connected to the cup holder 3, the lower end connecting structure 6 at the bottom of the cup body 1 is accommodated within the space 10 and engages with the second thread 31 via the first thread 11, thereby connecting the cup body 1 to the cup holder 3 and stably clamping the edge of the filter screen 2.

In this embodiment, by having the inner wall and the outer wall of the cup body 1 jointly form the lower end connecting structure 6 at the bottom surrounding the first opening 4, and providing the first thread 11 on an outer wall of the lower end connecting structure 6 and forming a pressing portion 7 for the edge of the filter screen 2 at the lower edge thereof, a connecting function of the bottom of the cup body 1 and a pressing and fixing function for the filter screen 2 are integrated into a same structural portion. Thus, when the cup body 1 and the cup holder 3 are connected through the first thread 11 and the second thread 31, the cup body 1 can apply an axial pressing force to the edge of the filter screen 2 while achieving a detachable connection with the cup holder 3, thereby reducing a need for additionally providing separate fixing structures such as pressing rings or pressing plates, and making an overall structure more compact.

Further, since the pressing portion 7 is provided surrounding the first opening 4 an forms an annular pressing corresponding to the edge of the filter screen 2, cooperating with a lower support of the cup holder 3 for the edge of the filter screen 2. the edge of the filter screen 2 may be subjected to more uniform force in a circumferential direction, which is conducive to improving a stability of the filter screen 2 after installation and reducing situations such as local warping, tilting, loosening or uneven force distribution of the filter screen 2 during operation.

Further, through a screwing cooperation of the first thread 11 and the second thread 31, the cup body 1 can gradually approach the cup holder 3 during a connection process, thereby forming a continuous and adjustable pressing effect on the edge of the filter screen 2. This not only facilitates improving a fixing reliability of the filter screen 2, but also facilitates ensuring a tighter fit between the edge of the filter screen 2 and the cup body 1 and the cup holder 3, thereby improving assembly stability.

Further, the lower end connecting structure 6 formed at the bottom of the cup body 1 surrounding the first opening 4, while achieving threaded connection and pressing the filter screen 2, also allows a central portion of the filter screen 2 to be correspondingly provided at the first opening 4, so that liquid can smoothly flow out through the first opening 4 after passing through the filter screen 2, without being easily blocked by improperly arranged pressing structures in a central liquid-passing region.

Further, the inner wall and the outer wall of the cup body 1 jointly forming the lower end connecting structure 6 at the bottom is also conducive to improving an integrity and local strength of the bottom of the cup body 1, so that a portion provided with the first thread 11 has good structural support, thereby facilitating an improvement of connection reliability when the cup body 1 and the cup holder 3 are repeatedly assembled and disassembled.

In this example, a cup wall of the cup body 1 adopts a double-layer design, as shown in FIG. 2. A hollow portion 12 is formed between the inner wall and the outer wall. The hollow portion 12 can provide an effect of heat insulation, making it convenient to hold. To enhance the effect of heat insulation, the hollow portion 12 may also be evacuated to form a vacuum or a quasi-vacuum.

FIG. 3 shows a side view of a preferred embodiment of the filter screen 2. Combined with FIG. 2, it may be seen that the filter screen 2 in this example differs from a traditional flat filter screen, being configured as a three-dimensional structure with a central portion lower than an edge portion and a multi-level step provided in the central portion as a transition. Further, each of the multi-level steps is provided with filter holes. The filter holes on steps 21 to 23 may be independently configured to be the same or different in terms of both shape and density. Compared with a filter screen with a traditional flat structure, a stepped structure firstly increases a contact area between coffee powder and air, which helps extract aroma from the coffee powder and improves coffee flavor. Additionally, a three-dimensional design with a low center and high periphery can prevent a formation of bubbles during water pouring, especially with boiling water. Reducing or avoiding the formation of bubbles can prevent a splashing of boiling water and coffee powder caused by bubble bursting.

The above embodiments are merely illustrative of the principles and effects of the present disclosure and are not intended to limit it. Anyone skilled in the art can modify or change the above embodiments without departing from the spirit and scope of the present disclosure. For example, the first thread 11 and the second thread 31 in the embodiment of FIG. 1 are only one implementation of the detachable fixed connection. Those skilled in the art will understand that replacing them with a snap fit or even using only a sleeve connection by interference fit falls under the same inventive concept. Therefore, all equivalent modifications or changes made by those with ordinary skill in the art without departing from the spirit and technical ideas disclosed by the present disclosure shall remain within the scope of the claims of the present disclosure.

What is claimed is:

1. A coffee filter cup, comprising a cup body, a filter screen, and a cup holder; wherein
a bottom of the cup body is hollowed to form a first opening, a second opening is provided in a middle of the cup holder, and the cup body and the cup holder are connected through a detachable fixed connection mode between the first opening and the second opening; and
when the cup body and the cup holder are in a connected state, an edge of the filter screen is clamped by the cup body and the cup holder.

2. The coffee filter cup according to claim 1, wherein the detachable fixed connection mode is selected from one of threaded connection, snap-fitting connection, or sleeve connection by interference fit.

3. The coffee filter cup according to claim 2, wherein when the detachable fixed connection mode is a threaded connection, the bottom of the cup body is provided with a first thread surrounding the first opening, and the cup holder is provided with a second thread cooperating with the first thread.

4. The coffee filter cup according to claim 1, wherein the cup body comprises an inner wall and an outer wall, with a hollow portion formed between the inner wall of the cup body and the outer wall of the cup body.

5. The coffee filter cup according to claim 4, wherein the hollow portion is evacuated to form a vacuum or quasi-vacuum.

6. The coffee filter cup according to claim 1, wherein the filter screen has a three-dimensional structure with a central portion lower than an edge portion.

7. The coffee filter cup according to claim 6, wherein the three-dimensional structure transitions between the central portion and the edge portion through multi-level steps.

8. The coffee filter cup according to claim 7, wherein each level of the multi-level steps is provided with filter holes.

9. The coffee filter cup according to claim 8, wherein the filter holes provided on each level of the multi-level steps have same or different shapes from each other.

10. The coffee filter cup according to claim 8, wherein the filter holes provided on each level of the multi-level steps have same or different densities from each other.

11. The coffee filter cup according to claim 1, wherein the bottom of the cup body forms a lower end connecting structure surrounding the first opening, and a lower edge of the lower end connecting structure constitutes an annular pressing portion for the edge of the filter screen.

12. The coffee filter cup according to claim 11, wherein the cup holder has an annular support portion, and when the cup body and the cup holder are connected, the annular support portion and the annular pressing portion jointly clamp the edge of the filter screen.

13. The coffee filter cup according to claim 12, wherein a wall structure is formed around the second opening, the wall structure comprises an inner wall and an outer wall, the inner wall of the wall structure is located on a side close to the second opening, and an upper edge of the inner wall of the wall structure constitutes the annular support portion; and
the inner wall of the wall structure and the outer wall of the wall structure are connected at a lower portion to form a space between the inner wall of the wall structure and the outer wall of the wall structure for accommodating the lower end connecting structure.
